(19) United States
(12) Patent Application Publication
(10) Pub. No.: US 2026/0086881 A1
(43) Pub. Date: Mar. 26, 2026

(54) MULTI-CLOUD PRIMARY NODE ELECTION

(71) Applicant: Dell Products L.P., Round Rock, TX (US)

(72) Inventors: Xueqiang ZHOU, Shanghai (CN); Jim Lewei JI, Shanghai (CN); Zhuo ZHANG, Shanghai (CN); Roy Shengli LING, Shanghai (CN); Yuan LI, Suzhou (CN); Chris Haitao LUO, Shanghai (CN); Donald MACE, Mashpee, MA (US)

(73) Assignee: Dell Products L.P., Round Rock, TX (US)

(21) Appl. No.: 18/894,734

(22) Filed: Sep. 24, 2024

(51) Int. Cl. G06F 9/50

(52) U.S. Cl. CPC G06F 9/5083

(57) ABSTRACT

An information handling system may include at least one processor and a memory. The information handling system may be configured to: select a single initial global primary node and a plurality of group primary nodes from a plurality of nodes of an information handling system cluster, wherein the plurality of group primary nodes are each associated with one of a corresponding plurality of cloud intents; receive a selection of a particular cloud intent; cause the nodes that are not associated with the particular cloud intent to shut down; and cause the group primary node associated with the particular cloud intent to replacing the initial global primary node as the global primary node for the cluster of information handling systems.

### TECHNICAL FIELD

The present disclosure relates in general to information handling systems, and more particularly to the election of a primary node in a cluster of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Some HCI systems use a cloud platform manager (e.g., APEX Cloud Platform™ from Dell®) for handling various cloud management tasks. For example, a cloud platform manager May be used to install a particular cloud OS onto an HCI cluster to prepare it for use with a particular cloud platform (e.g., Amazon® AWS, Microsoft Azure, Google® Cloud Platform, etc.). The choice of a particular cloud platform for a cluster is sometimes referred to as the cluster's “cloud intent.”

In some cases, a cluster may include one node designated as the primary node, which can act as the bootstrap node for setting up and provisioning the cluster. In one implementation, the primary node may be elected by powering on the nodes to be provisioned and allowing them to auto-discover each other over the network. To elect a primary node, some designated characteristic of the nodes (e.g., their serial numbers) may be compared. The node with the lowest serial number may then be designated as the primary node. The primary node may present a wizard to the user to input information for cluster provisioning and handle the rest of the provisioning process.

However, this type of election algorithm may not be suitable in situations where the customer's environment contains physical nodes that are associated with more than one cloud intent. For example, if a datacenter has some nodes associated with one cloud intent and other nodes associated with a different cloud intent, and they are all powered on at the same time, the existing primary election algorithm may not correctly differentiate the nodes based on their cloud intents.

Embodiments of this disclosure are thus directed to techniques for electing the primary node that are suitable when multiple cloud intents are present.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with primary node election may be reduced or eliminated.

In accordance with embodiments of the present disclosure, an information handling system may include at least one processor and a memory. The information handling system may be configured to: select a single initial global primary node and a plurality of group primary nodes from a an information handling system plurality of nodes of cluster, wherein the plurality of group primary nodes are each associated with one of a corresponding plurality of cloud intents; receive a selection of a particular cloud intent; cause the nodes that are not associated with the particular cloud intent to shut down; and cause the group primary node associated with the particular cloud intent to replacing the initial global primary node as the global primary node for the cluster of information handling systems.

In accordance with these and other embodiments of the present disclosure, a method may include an information handling system selecting a single initial global primary node and a plurality of group primary nodes from a plurality of nodes of an information handling system cluster, wherein the plurality of group primary nodes are each associated with one of a corresponding plurality of cloud intents; the information handling system receiving a selection of a particular cloud intent; the information handling system causing the nodes that are not associated with the particular cloud intent to shut down; and the information handling system causing the group primary node associated with the particular cloud intent to replacing the initial global primary node as the global primary node for the cluster of information handling systems.

In accordance with these and other embodiments of the present disclosure, an article of manufacture may include a non-transitory, computer-readable medium having computer-executable instructions thereon that are executable by an information handling system for: selecting a single initial global primary node and a plurality of group primary nodes from a plurality of nodes of an information handling system cluster, wherein the plurality of group primary nodes are each associated with one of a corresponding plurality of cloud intents; receiving a selection of a particular cloud intent; causing the nodes that are not associated with the particular cloud intent to shut down; and causing the group primary node associated with the particular cloud intent to replacing the initial global primary node as the global primary node for the cluster of information handling systems.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIGS. 2-3 illustrate example methods, in accordance with embodiments of the present disclosure.

### DETAILED DESCRIPTION

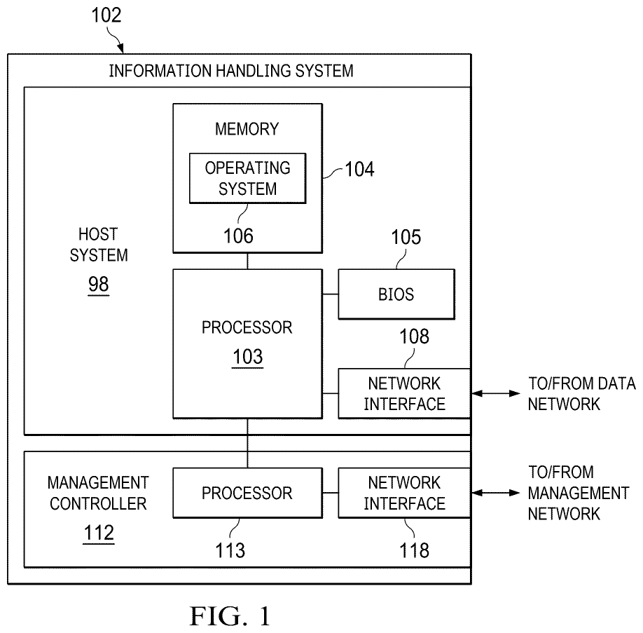

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may be used to elect a primary node in a cluster of information handling systems 102, particularly in the situation in which multiple cloud intents are present in a given environment. Embodiments may rely on a primary election algorithm that uses two types of keys, referred to as global keys and group keys. Each node may be associated with both a global key and a group key.

When the user initiates the powering on of nodes, which may include various cloud intentions, the nodes may undergo automatic discovery to identify and share their cloud intentions and serial numbers. Each node's group key may be derived based solely on the serial number (or some other physical node information). For example, the group key may be equal to the serial number. A node's global key may be derived based on a combination of the node's cloud intent information and its serial number (or some other physical node information). For example, the global key may be formed by concatenating those two items.

Two types of primary node according to the two key types may then be elected as follows.

A global primary node may be elected based on the global keys, and a group primary node for each cloud intent group may be elected based on the group keys. For example, the nodes having the smallest value for each key type may be elected as the respective primary nodes. The cluster provisioning wizard mentioned above may then be provided by the global primary node.

The overall election process may consist of two phases: an initial discovery and election phase, and a cloud intent selection and global primary adjustment phase.

Table 1 below shows an example set of nodes immediately after they have been powered on. The underlined nodes are those that are selected as global and/or group primary.

TABLE 1

| Power | Cloud | Serial | Global | Group | Global | Group |
|---|---|---|---|---|---|---|
| Status | Intent | Number | Key | Key | Primary | Primary |
| On | 001 | 10002 | 001-10002 | 10002 | Y | Y |
| On | 001 | 10003 | 001-10003 | 10003 | N | N |
| On | 001 | 20001 | 001-20001 | 20001 | N | N |
| On | 002 | 10001 | 002-10001 | 10001 | N | Y |
| On | 002 | 20002 | 002-20002 | 20002 | N | N |
| On | 002 | 20003 | 002-20003 | 20003 | N | N |

Once these nodes have been brought online and completed the initial discovery and election phase, the user may be prompted to select a single cloud intent to set up first. If the user selects cloud intent 001, then the nodes associated with cloud intent 002 may be powered down (and vice versa).

Thus if the user selects cloud intent 001, then the current global primary node may remain in place as primary while the nodes associated with cloud intent 002 are powered off. This situation is reflected in Table 2 below.

TABLE 2

| Power | Cloud | Serial | Global | Group | Global | Group |
|---|---|---|---|---|---|---|
| Status | Intent | Number | Key | Key | Primary | Primary |
| On | 001 | 10002 | 001-10002 | 10002 | Y | Y |
| On | 001 | 10003 | 001-10003 | 10003 | N | N |
| On | 001 | 20001 | 001-20001 | 20001 | N | N |
| Off | 002 | 10001 | 002-10001 | 10001 | N | N |
| Off | 002 | 20002 | 002-20002 | 20002 | N | N |
| Off | 002 | 20003 | 002-20003 | 20003 | N | N |

Alternatively, if the user chooses to set up cloud intent 002, then the nodes associated with cloud intent 001may be powered off. The global primary node may then be switched to the group primary node for cloud intent 002.This situation is reflected in Table 3 below.

TABLE 3

| Power | Cloud | Serial | Global | Group | Global | Group |
|---|---|---|---|---|---|---|
| Status | Intent | Number | Key | Key | Primary | Primary |
| Off | 001 | 10002 | 001-10002 | 10002 | N | N |
| Off | 001 | 10003 | 001-10003 | 10003 | N | N |
| Off | 001 | 20001 | 001-20001 | 20001 | N | N |
| On | 002 | 10001 | 002-10001 | 10001 | Y | Y |
| On | 002 | 20002 | 002-20002 | 20002 | N | N |
| On | 002 | 20003 | 002-20003 | 20003 | N | N |

In either case, the provisioning process may proceed with the selected cloud intent and its primary node. (The user may then at a later time power the remaining nodes on and provision them separately.)

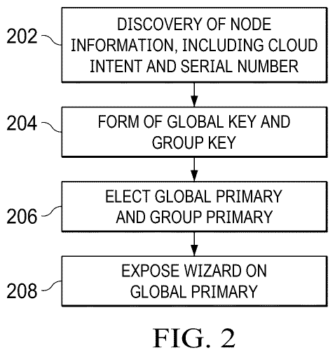

Turning now to FIG. 2, an example method for the initial discovery and election phase is shown. At step 202, the nodes may be powered on and perform automatic discovery over the network, including informing one another of their serial numbers and cloud intents. At step 204, the nodes may each derive a global key and group key based on the serial number and cloud intent information. These keys may also be shared during the auto-discovery process.

At step 206, the nodes may elect a global primary, as well as a group primary for each cloud intent group. At step 208, the global primary may provide a provisioning wizard to the user.

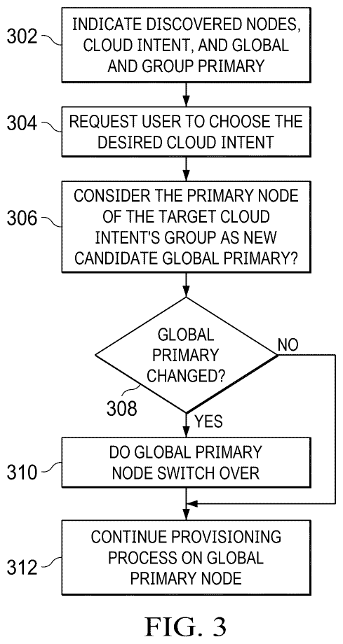

Turning now to FIG. 3, an example method for the cloud intent selection and global primary adjustment phase is shown. At step 302, the wizard may present the user with information regarding the discovered nodes, the available cloud intents, and the elected primary nodes.

At step 304, the user may select one cloud intent to set up. At step 306, the system may determine whether or not the group primary of the selected cloud intent should be considered as a new candidate global primary. For example, if the user selects a cloud intent that is different from the current global primary node's cloud intent, then the current global primary will be shut down, and the group primary for the selected cloud intent should take over at steps 308-310. The system may then continue the provisioning process with the selected global primary at step 312.

One of ordinary skill in the art with the benefit of this disclosure will understand that the preferred initialization point for the methods depicted in FIGS. 2 and 3 and the order of the steps comprising those methods may depend on the implementation chosen. In these and other embodiments, these methods may be implemented as hardware, firmware, software, applications, functions, libraries, or other instructions. Further, although FIGS. 2 and 3 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
select a single initial global primary node and a plurality of group primary nodes from a plurality of nodes of an information handling system cluster, wherein the plurality of group primary nodes are each associated with one of a corresponding plurality of cloud intents;
receive a selection of a particular cloud intent;
cause the nodes that are not associated with the particular cloud intent to shut down; and
cause the group primary node associated with the particular cloud intent to replacing the initial global primary node as the global primary node for the cluster of information handling systems.

2. The information handling system of claim 1, wherein the global primary node is selected based on global keys associated with each of the plurality of nodes, and the group primary nodes are selected based on group keys associated with each of the plurality of nodes.

3. The information handling system of claim 2, wherein the group key for each node is equal to a serial number for that node.

4. The information handling system of claim 2, wherein the global key for each node is based on a combination of a serial number for that node and a cloud intent for that node.

5. The information handling system of claim 2, wherein the node having the smallest numerical value of global key is selected as the global primary node.

6. The information handling system of claim 1, wherein the receiving the selection of the particular cloud intent is carried out by a wizard executing on the initial global primary node.

7. A method comprising:
an information handling system selecting a single initial global primary node and a plurality of group primary nodes from a plurality of nodes of an information handling system cluster, wherein the plurality of group primary nodes are each associated with one of a corresponding plurality of cloud intents;
the information handling system receiving a selection of a particular cloud intent;
the information handling system causing the nodes that are not associated with the particular cloud intent to shut down; and
the information handling system causing the group primary node associated with the particular cloud intent to replacing the initial global primary node as the global primary node for the cluster of information handling systems.

8. The method of claim 7, wherein the global primary node is selected based on global keys associated with each of the plurality of nodes, and the group primary nodes are selected based on group keys associated with each of the plurality of nodes.

9. The method of claim 8, wherein the group key for each node is equal to a serial number for that node.

10. The method of claim 8, wherein the global key for each node is based on a combination of a serial number for that node and a cloud intent for that node.

11. The method of claim 8, wherein the node having the smallest numerical value of global key is selected as the global primary node.

12. The method of claim 7, wherein the receiving the selection of the particular cloud intent is carried out by a wizard executing on the initial global primary node.

13. An article of manufacture comprising a non-transitory, computer-readable medium having computer-executable instructions thereon that are executable by an information handling system for:
selecting a single initial global primary node and a plurality of group primary nodes from a plurality of nodes of an information handling system cluster, wherein the plurality of group primary nodes are each associated with one of a corresponding plurality of cloud intents;
receiving a selection of a particular cloud intent;
causing the nodes that are not associated with the particular cloud intent to shut down; and
causing the group primary node associated with the particular cloud intent to replacing the initial global primary node as the global primary node for the cluster of information handling systems.

14. The article of claim 13, wherein the global primary node is selected based on global keys associated with each of the plurality of nodes, and the group primary nodes are selected based on group keys associated with each of the plurality of nodes.

15. The article of claim 14, wherein the group key for each node is equal to a serial number for that node.

16. The article of claim 14, wherein the global key for each node is based on a combination of a serial number for that node and a cloud intent for that node.

17. The article of claim 14, wherein the node having the smallest numerical value of global key is selected as the global primary node.

18. The article of claim 13, wherein the receiving the selection of the particular cloud intent is carried out by a wizard executing on the initial global primary node.
